(19) United States
(12) Patent Application Publication
(10) Pub. No.: US 2015/0153590 A1
(43) Pub. Date: Jun. 4, 2015

(54) EYEGLASSES WITH ADJUSTABLE LIGHT PENETRATION AND LIGHT PENETRATION ADJUSTING METHOD THEREOF

(71) Applicant: PIXART IMAGING INC., Hsin-Chu County (TW)

(72) Inventors: CHU-LEIK HO, PENANG (MY); ANDREW KHOO, PENANG (MY)

(73) Assignee: PIXART IMAGING INC., Hsin-Chu County (TW)

(21) Appl. No.: 14/093,655

(22) Filed: Dec. 2, 2013

(51) Int. Cl. G02C 7/10; G06F 3/044; G02C 11/00

(52) U.S. Cl. CPC G02C 7/101; G02C 11/10; G06F 3/044

(57) ABSTRACT

There is provided eyeglasses with adjustable light penetration including two lenses, a power source and a control device. The two lenses respectively include two electrodes and a liquid crystal layer sandwiched between the two electrodes. The power source is electrically coupled to the two electrodes of the two lenses through the control device. The control device is configured to control an electrical signal provided from the power source to the two electrodes thereby adjusting a light penetration rate of the liquid crystal layer.

### BACKGROUND

1. Field of the Disclosure

This disclosure generally relates to eyeglasses and, more particularly, to eyeglasses and a light penetration adjusting method thereof in which the light penetration may be regulated by a user.

2. Description of the Related Art

In order to block UV light and reduce the light penetration, two lenses of the traditional sunglasses are directly manufactured as dark lenses. However, if a user wears this kind of sunglasses entering a building, the user's eye may not be able to immediately accommodate itself to the ambient light change such that the environmental situation can not be seen clearly. Accordingly, the user has to take off this kind of sunglasses to prevent accidents when entering a dark environment from a bright environment.

In order to solve the above problem in traditional sunglasses, the industry proposed photochromic lenses that can change the color by absorbing UV light so as to change the light penetration thereof. However, this kind of photochromic lenses still has following problems. A long color change time is required.

When the ambient light changes abruptly, the problem of the user's eye not being able to immediately accommodate itself to this abrupt change still exists. In addition, the color change may not happen when driving a car and this is because the glass of the vehicle and the car insulation paper can stop UV light entering the vehicle such that this kind of photochromic lenses can not absorb enough UV light for changing the color. Accordingly, it is not suitable to wear the eyeglasses adopting this kind of photochromic lenses in driving a car.

Accordingly, the present disclosure further provides eyeglasses with adjustable light penetration and a light penetration adjusting method thereof in which the required light penetration may be easily selected by a user himself/herself so as to be adapted to various ambient light changes.

### SUMMARY

The present disclosure provides eyeglasses with adjustable light penetration and a light penetration adjusting method thereof that may adopt a capacitance control slider to control a voltage difference provided to liquid crystal devices opposite to the lenses thereby regulating the light penetration of the lenses.

The present disclosure further provides eyeglasses with adjustable light penetration and a light penetration adjusting method thereof in which the light penetration of lenses may be selected by a user himself/herself so as to be adapted to various ambient light changes.

The present disclosure provides eyeglasses with adjustable light penetration including a power source, two lenses and a capacitive touch device. The two lenses respectively include two electrodes and a liquid crystal layer sandwiched between the two electrodes. The capacitive touch device is configured to control an electrical signal provided from the power source to the two electrodes according to a touch position thereby adjusting a light penetration rate of the liquid crystal layer.

The present disclosure further provides a light penetration adjusting method of eyeglasses. The eyeglasses include a capacitive touch device, a power source, two lenses and two liquid crystal devices respectively opposite to the two lenses. The light penetration adjusting method includes the steps of: detecting, using the capacitive touch device, a capacitance variation; identifying, using the capacitive touch device, a touch position according to the capacitance variation; and controlling an electrical signal provided from the power source to the two liquid crystal devices according to the touch position thereby adjusting a light penetration of the two lenses.

The present disclosure further provides eyeglasses with adjustable light penetration including a power source, two lenses, two liquid crystal devices and a control device. The two liquid crystal devices are respectively opposite to the two lenses. The control device is configured to control an electrical signal provided from the power source to the two liquid crystal devices thereby adjusting a light penetration of the two lenses.

In one aspect, the capacitive touch device may include a touch plate having a long stripe shape and disposed in one of the two eyeglass temples, wherein the touch plate having a long stripe shape is preferably exposed outside of the eyeglass temple for operation convenience.

In one aspect, the power source may be a battery and disposed in an eyeglass frame or one end of an eyeglass temple close to the lenses.

In one aspect, the electrical signal may be a current signal or a voltage signal. The light penetration rate of the liquid crystal devices and the light penetration of the lenses may be positively or negatively correlated with a value of the current signal, or may be positively or negatively correlated with a value of the voltage signal.

In one aspect, the liquid crystal layer may be a polymer dispersion liquid crystal (PDLC) layer.

In the eyeglasses with adjustable light penetration and a light penetration adjusting method thereof according to the embodiment of the present disclosure, the desired light penetration may be easily regulated by touching different positions of a capacitance control slider so as to be adapted to various ambient light changes thereby effectively solving the problems in the conventional photochromic lenses and dark lenses.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of the eyeglasses with adjustable light penetration according to an embodiment of the present disclosure.

FIG. 2 shows a schematic block diagram of the eyeglasses with adjustable light penetration according to an embodiment of the present disclosure.

FIG. 3 shows an operational diagram of the eyeglasses with adjustable light penetration according to the embodiment of the present disclosure.

FIG. 4 shows a flow chart of the light penetration adjusting method of eyeglasses according to the embodiment of the present disclosure.

### DETAILED DESCRIPTION OF THE EMBODIMENT

It should be noted that, wherever possible, the same reference numbers will be used throughout the drawings to refer to the same or like parts.

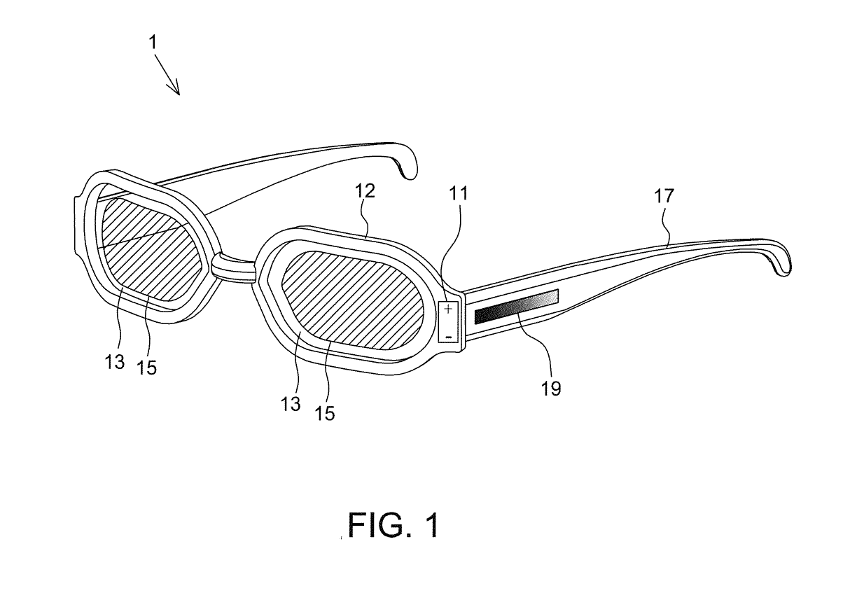

Referring to FIG. 1, it shows a schematic diagram of the eyeglasses with adjustable light penetration according to an embodiment of the present disclosure. In the eyeglasses 1 of the present disclosure, the light penetration of the lenses may be selected by a user himself/herself so as to be adapted to various ambient light changes.

The eyeglasses 1 include a power source 11, an eyeglass frame 12, two lenses 13, two liquid crystal devices 15, two eyeglass temples 17 and a capacitive touch device 19, wherein the two liquid crystal devices 15 are respectively disposed opposite to the two lenses 13 and configured to control the penetration of light passing trough the two liquid crystal devices 15 and the two lenses 13; the power source 11 is electrically coupled to the two liquid crystal devices 15 and the capacitive touch device 19 configured to provide the power required in operation; and the power source 11 may be a battery which may be disposed in the eyeglass frame 12 or one end of one of the two eyeglass temples 17 close to the lenses 13, but not limited to. The disposed position of the power source 11 may be determined according to different designs of the eyeglasses 1.

It is appreciated that the appearance of the eyeglasses 1 is not limited to that shown in FIG. 1. In one embodiment, the two liquid crystal devices 15 may be directly formed on the two lenses 13 respectively. In another embodiment, the two liquid crystal devices 15 may be separated from the two lenses 13, and before operation the two liquid crystal devices 15 are combined with the eyeglass frame 12, e.g. via a supporting member, and electrically coupled to the capacitive touch device 19 such that it is not necessary to form the liquid crystal devices directly on the specific lenses. For example an eyeglass frame may be integrated with the power source 11, the capacitive touch device 19 and an electrical contact. The supporting member may be integrated with two liquid crystal devices 15 and another electrical contact associated with the electrical contact of the eyeglass frame. In this manner, when the two liquid crystal devices 15 are combined with the eyeglass frame via the supporting member, the controlling of the light penetration of the lenses may also be realized. Preferably, areas of the two liquid crystal devices 15 are substantially identical to those of the two lenses 13 so as to achieve good light limiting effect. In order to show two elements clearly, areas of the two liquid crystal devices 15 are shown to be smaller than those of the two lenses 13 in FIG. 1, but the present disclosure is not limited thereto.

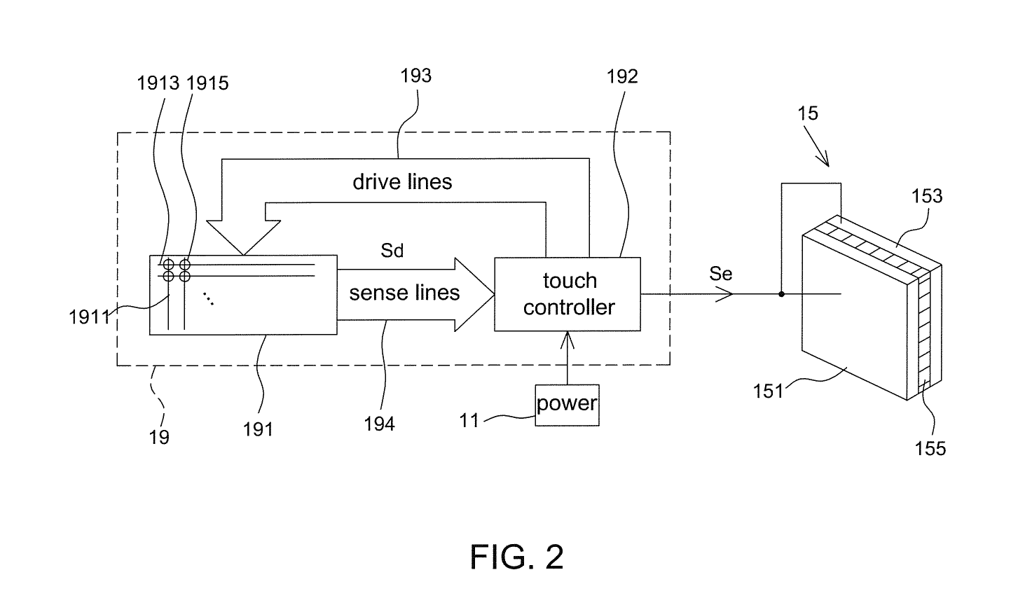

Referring to FIG. 2, it shows a schematic block diagram of the eyeglasses with adjustable light penetration according to an embodiment of the present disclosure.

The capacitive touch device 19 includes a capacitive touch panel 191, a touch controller 192, a plurality of drive lines 193 and a plurality of sense lines 194, wherein the number of the drive lines 193 and the sense lines 194 may be determined according to the resolution and size of the capacitive touch panel 191 without particular limitation. The drive lines 193 are configured to transmit the drive signal and the sense lines 194 are configured to transmit the detected signal Sd.

The capacitive touch panel 191 includes at least one substrate, a plurality of parallel drive electrodes 1911 disposed longitudinally or transversely and a plurality of sense electrodes 1913 crossing over the drive electrodes 1911. Crossing points of the drive electrodes 1911 and the sense electrodes 1913 form sensing cells 1915 arranged in matrix and each of the sensing cells 1915 has a capacitance value, wherein the method of forming a plurality of drive electrodes and sense electrodes on a substrate is well known and thus details thereof are not described herein. In this manner, when an object (e.g. a finger) touches or approaches to the sensing cells 1915, the capacitance of the sensing cells 1915 is changed to further influence a detected signal Sd outputted from the sense lines 194.

The touch controller 192 identifies whether the capacitance variation associated with each sensing cell 1915 exceeds a variation threshold according to the detected signal Sd so as to determine a touch position (i.e. the position of the sensing cell having the capacitance variation exceeding the variation threshold), wherein the method of the touch controller 192 identifying at least one touch position according to the detected signal Sd is well known and thus details thereof are not described herein. The present disclosure is to allow the touch controller 192 to determine an electrical signal Se (e.g. a current signal or a voltage signal) provided from the power source 11 to the two liquid crystal devices 15 according to the touch position so as to change a light penetration rate of the liquid crystal layer thereby adjusting a light penetration of the two lenses 13. In one embodiment, the capacitive touch device 19 may be a capacitance control slider.

Referring to FIG. 1 again, the capacitive touch device 19 may include a touch plate having a long strip shape and may be disposed (e.g. embedded) in one of the two eyeglass temples 17. The touch plate having a long strip shape is preferably exposed outside of the eyeglass temple 17 as shown in FIG. 1 such that it is convenient for the user to operate, wherein the touch plate having a long strip shape may be one of or an extension part of the first electrode 151 and the second electrode 153. When the finger of user touches one end of the touch plate having a long strip shape, the touch controller 192 may output a maximum value of the electrical signal Se; whereas when the finger of user touches the other end of the touch plate having a long strip shape, the touch controller 192 may output a minimum value of the electrical signal Se.

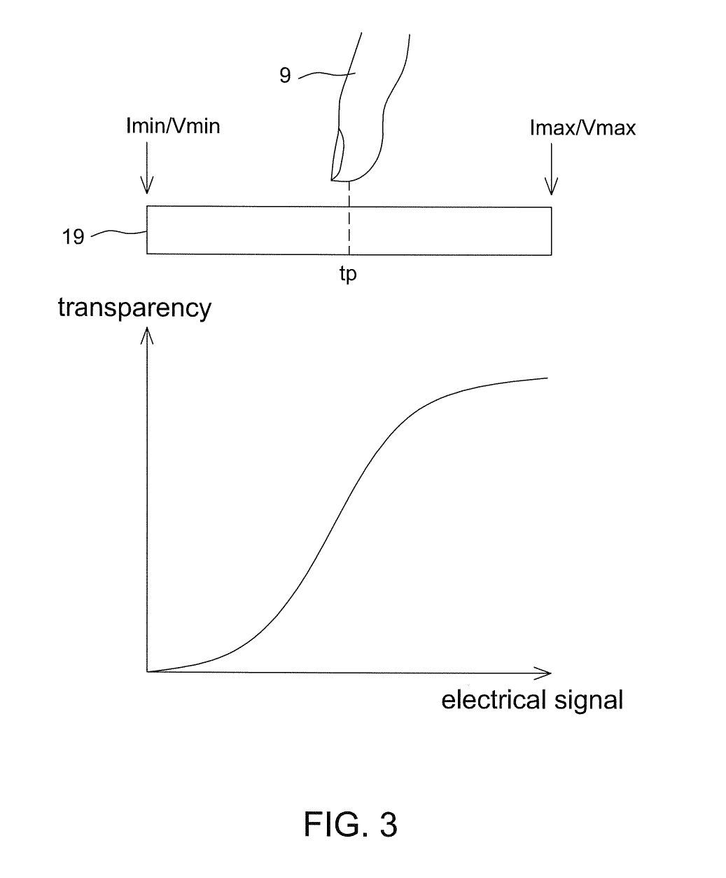

Referring to FIG. 3, it shows an operational diagram of the eyeglasses with adjustable light penetration according to the embodiment of the present disclosure. When a finger 9 is at a touch position tp of the capacitive touch device 19, a corresponding value of the current signal or the voltage signal is obtained, wherein a relationship between the touch position tp and the electrical signal Se may be previously set and stored in a storage unit (not shown) of the capacitive touch device 19. In addition, FIG. 3 further shows a relationship diagram of the electrical signal Se versus the light penetration, and it is shown that when the electrical signal Se has a larger value, the two liquid crystal devices 15 have a higher light penetration, wherein the light penetration may also be replaced by the light penetration rate. It should be mentioned that although FIG. 3 shows that the light penetration is positively correlated with a value of the electrical signal Se, it is not to limit the present disclosure. According to different applications, the light penetration may be negatively correlated with a value of the electrical signal Se.

The two liquid crystal devices 15 respectively include a first electrode 151, a second electrode 153 and a liquid crystal layer 155 sandwiched between the first electrode 151 and the second electrode 153, wherein the two liquid crystal devices 15 may be located at an inner surface or an outer surface of the two lenses 15 according to different applications and without particular limitation. In this embodiment, the liquid crystal layer 155 may be a polymer dispersion liquid crystal (PDLC) layer and may change the light penetration rate thereof according to a voltage difference applied between the first electrode 151 and the second electrode 153 to accordingly regulate the light penetration of the two lenses 13. However, the liquid crystal layer 155 is not limited to the polymer dispersion liquid crystal layer, and it may be any liquid crystal layer without particular limitation as long as it has the changeable light penetration rate according to the electrical field applied thereon. In the present disclosure, the capacitive touch device 19 may output the current signal or voltage signal. When the capacitive touch device 19 outputs the current signal, the two liquid crystal devices 15 may respectively further include a current-to-voltage converter configured to convert the current signal to the voltage signal, and the voltage signal is then provided to the first electrode 151 and the second electrode 153.

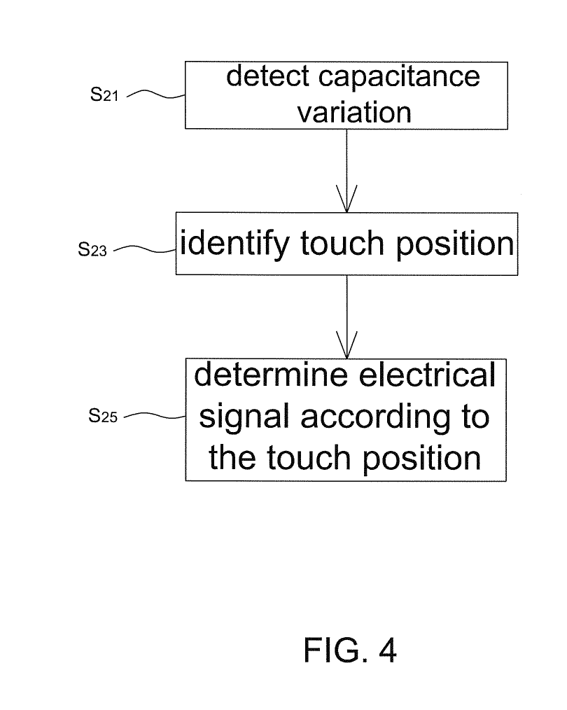

Referring to FIG. 4, it shows a flow chart of the light penetration adjusting method of eyeglasses according to the embodiment of the present disclosure, which includes the steps of: detecting a capacitance variation (Step S₂₁); identifying a touch position (Step S₂₃); and determining an electrical signal according to the touch position (Step S₂₅). Referring to FIGS. 1-4 together, details of this embodiment are described hereinafter.

Step S₂₁: A user touches a touch position tp of the capacitive touch panel 191 with his or her finger 9, and the capacitive touch panel 191 induces a capacitance variation, which is reflected in the detected signal Sd, on at least one sensing cell 1915 corresponding to the touch position tp.

Step S₂₃: The touch controller 192 of the capacitive touch device 19 detects a capacitance variation according to the detected signal Sd and identifies the touch position tp according to the position of the sensing cell 1915 inducing the capacitance variation. For example, when the capacitive touch panel 191 does not detect any capacitance variation, all sensing cells 1915 output the detected signal Sd having a digital value substantially equal to 0. When at least one sensing cell 1915 detects the capacitance variation, the at least one sensing cell 1915 outputs the detected signal Sd having a digital value larger than 0. When a plurality of adjacent sensing cells 1915 detect the capacitance variation simultaneously, the touch controller 192 may take a geometric center or a gravity center of these adjacent sensing cells 1915 as the touch position tp. As mentioned above, if the capacitive touch device 19 employs the touch plate having a long stripe shape (e.g. 1×n or 2×n sensing cells), the touch position can be identified easily.

Step S₂₅: The touch controller 192 of the capacitive touch device 19 outputs the electrical signal Se according to a previously stored relationship between the touch position tp and the electrical signal Se to the two electrodes 151 and 153 of the two liquid crystal devices 15, wherein as shown in FIG. 3 different values of the electrical signal Se are associated with a corresponding light penetration (or light penetration rate). The user may continuously change the touch position tp according to the light penetration actually felt so as to achieve the desired light penetration, and the capacitive touch device 19 real-timely changes the detected signal Se corresponding to the change of the touch position tp.

It should be mentioned that in the above embodiments although an electrical signal Se provided from the power source 11 to the liquid crystal devices 15 is controlled by a capacitive touch device 19, it is not to limit the present disclosure. The capacitive touch device 19 may be replaced by other control devices capable of controlling the voltage value or current value, e.g. replaced by a variable resistor. Any control device that can control the electrical signal Se provided to the liquid crystal devices 15 may be used to replace the capacitive touch device 19 without particular limitation.

As mentioned above, the conventional dark lenses and photochromic lenses are not suitable to be applied to some conditions. Therefore, the present disclosure further provides eyeglasses with adjustable light penetration (FIGS. 1 and 2) and a light penetration adjusting method thereof (FIG. 4) in which the light penetration may be selected by a user himself/herself so as to be adapted to various ambient light changes.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. Eyeglasses with adjustable light penetration, comprising:
a power source;
two lenses respectively comprising two electrodes and a liquid crystal layer sandwiched between the two electrodes; and
a capacitive touch device configured to control an electrical signal provided from the power source to the two electrodes according to a touch position thereby adjusting a light penetration rate of the liquid crystal layer.

2. The eyeglasses as claimed in claim 1, wherein the capacitive touch device is disposed on an eyeglass temple.

3. The eyeglasses as claimed in claim 1, wherein the power source is a battery and is disposed in an eyeglass frame or one end of an eyeglass temple close to the lenses.

4. The eyeglasses as claimed in claim 1, wherein the liquid crystal layer is a polymer dispersion liquid crystal layer.

5. The eyeglasses as claimed in claim 1, wherein the capacitive touch device comprises a touch plate having a long stripe shape.

6. The eyeglasses as claimed in claim 1, wherein the electrical signal is a current signal or a voltage signal.

7. The eyeglasses as claimed in claim 6, wherein the light penetration rate is positively or negatively correlated with a value of the current signal, or positively or negatively correlated with a value of the voltage signal.

8. A light penetration adjusting method of eyeglasses, the eyeglasses comprising a capacitive touch device, a power source, two lenses and two liquid crystal devices respectively opposite to the two lenses, the light penetration adjusting method comprising:
detecting, using the capacitive touch device, a capacitance variation;
identifying, using the capacitive touch device, a touch position according to the capacitance variation; and
controlling an electrical signal provided from the power source to the two liquid crystal devices according to the touch position thereby adjusting a light penetration of the two lenses.

9. The light penetration adjusting method as claimed in claim 8, wherein the electrical signal is a current signal or a voltage signal.

10. The light penetration adjusting method as claimed in claim 9, wherein the light penetration is positively or negatively correlated with a value of the current signal, or positively or negatively correlated with a value of the voltage signal.

11. Eyeglasses with adjustable light penetration, comprising:
a power source;
two lenses;
two liquid crystal devices respectively opposite to the two lenses; and
a control device configured to control an electrical signal provided from the power source to the two liquid crystal devices thereby adjusting a light penetration of the two lenses.

12. The eyeglasses as claimed in claim 11, wherein the control device is a variable resistor or a capacitive touch device.

13. The eyeglasses as claimed in claim 12, wherein the capacitive touch device comprises a touch plate having a long stripe shape.

14. The eyeglasses as claimed in claim 11, wherein the control device is disposed on an eyeglass temple.

15. The eyeglasses as claimed in claim 11, wherein the power source is a battery and is disposed in an eyeglass frame or one end of an eyeglass temple close to the lenses.

16. The eyeglasses as claimed in claim 11, wherein the two liquid crystal devices respectively comprise two electrodes and a polymer dispersion liquid crystal layer sandwiched between the two electrodes.

17. The eyeglasses as claimed in claim 11, wherein the electrical signal is a current signal or a voltage signal.

18. The eyeglasses as claimed in claim 17, wherein the light penetration is positively or negatively correlated with a value of the current signal, or positively or negatively correlated with a value of the voltage signal.
